(19) United States
(12) Patent Application Publication
(10) Pub. No.: US 2010/0159115 A1
(43) Pub. Date: Jun. 24, 2010

(54) FLAVONOID-RICH CITRUS EXTRACT PROCESS

(76) Inventors: Niv Ben Yehuda, Winter Haven, FL (US); Timothy A. Anglea, Windermere, FL (US)

Correspondence Address: PARKS IP LAW/TCCC, 1117 PERIMETER CENTER WEST, SUITE E402, ATLANTA, GA, 30338, US

(21) Appl. No.: 12/340,215

(22) Filed: Dec. 19, 2008

(51) Int. Cl. A23L 1/28

(52) U.S. Cl. 426/655

(57) ABSTRACT

Extraction of flavonoid citrus extract from the by-product of a juice extraction process, to provide a flavonoid-rich citrus extract is disclosed. The extraction process reduces the level of limonin and/or bitterants in the by-product extract without affecting the level of naturally occurring flavonoids, which may be added to citrus-base or non-citrus-based beverages, or used as a stand-alone juice.

### FIELD OF THE INVENTION

The present invention relates generally to a process for extracting a flavonoid citrus extract from the by-product of a conventional citrus juice process. The present invention is also directed to a flavonoid citrus extract containing high levels of nutritionally important phytochemicals that can be added to beverages, such as citrus-based and non-citrus-based beverages or used as a stand-alone juice.

### BACKGROUND OF THE INVENTION

Citrus fruits have long been recognized as containing valuable sources of important nutrients which are biologically active in humans. U.S. Patent Application Publication No. US 2002/006953 A1. Growing evidence suggests that certain nutrients found in citrus sources, such as flavonoids and limonoids, play a major role in treating or retarding chronic diseases, including anti-oxidative, anti-carcinogenic, cardiovascular protective, neuro-protective, bone health promotion and anti-inflammatory diseases.

Citrus fruits, such as oranges, contain compounds called phytochemicals that can be included into three major groups: the flavonoids, limonoids and carotenoids. The flavonoids are a group of benzopyran derivatives which occur widely in plants. The flavonoids typically consist of a benzene ring fused with the heterocyclic six-membered ring containing an oxygen atom. Many flavonoids may also exist as glycosides. The flavonoids in citrus also include the flavone polymethoxylated flavone (in oranges). This compound is represented by flavones substituted by methoxy groups and is unique to citrus. The polymethoxylated flavones have shown cholesterol and lipid lowering potential in animals and possibly humans, and the potential for treating diabetes and inflammation.

In citrus fruits, the most predominant flavonoids are the flavanones hesperidin, narirutin and didymin (in oranges). The flavonoid compounds have been studied for their potential use in the treatment of degenerative and infective diseases.

Triterpene derivatives known as limonoids commonly occur in citrus fruits. The liminoids may exist as aglycones, or be linked to a glucose molecule (the glucoside). It is believed that limonoids may be useful in treating ailments associated with cancer, and may also have the potential for treating cardiovascular disease and for antiviral activity.

The carotenoids are tetraterpenoid compounds which occur widely in plants and other photosynthetic organisms. The carotenoid profile of citrus fruits, such as oranges, is complex, and the identity, number and concentration of carotenoids in orange juice is controversial. Zeaxanthin, lutein, β-cryptoxanthin, α-carotene and β-carotene are the major carotenoids in orange juice. These carotenoids are bioavailable, but it is unclear whether the biological effects in humans are related to their antioxidant activity or other non-antioxidant activities. Nevertheless, there are promising animal results regarding the use of beta-cryptoxanthin to reduce the risk of inflammatory disorders, e.g., rheumatoid arthritis and for the prevention of bone loss.

Important quantities of useful naturally- occurring phytochemicals such as flavonoid compounds, including flavones and flavanones, and limonoids are lost during the conventional juice extraction process, which processes juice from the whole fruit or plant and discards the peel, core and/or other components that are considered waste material useful in the production of livestock feed. It is also known that when certain by-products of the juice extraction process, such as the citrus peel is further processed to obtain a natural clouding agent for beverages, such as juices, the level of naturally occurring phytochemicals is usually reduced or removed during the debittering process as it is believed that these phytochemicals detract from the quality of the citrus or plant juice.

Citrus fruits are a growing industry with significant world importance. Citrus fruits, such as oranges, tangerines, mandarin, blood oranges, grapefruit, lemon and limes are utilized primary for juice recovery. The by-products industry also has a potential for growth since products have also been produced from citrus fruit residues. The citrus peel residue is the primary by-product amounting up to 30%, while the cell, core and membrane and frit residues present an additional 20% of the by-product industry. In most cases, this huge amount of waste material is the source for cattle feed only, while in other cases, products such as molasses, oils, D-limonene, pectin and flavonoids can be extracted and used. An alternative use of citrus by-products is concentrating the solid extract to obtain higher solid extracts, which are believed to improve the organoleptic properties by removing of the so called “undesirable components” on resin columns. US Patent Application Publication No. 2004/0081734 A1.

For example, US Patent Application Publication No. 2006/9195089 A1 describes a process of extracting the citrus peel by-product from a citrus juice extraction process, to obtain a refined citrus peel juice which can be used as a filler juice suitable for blending with other juices or as a stand alone juice. In this publication, the peel juice is passed through a debittering column on a divinylbenzene adsorption resin to substantially reduce the level of naturally occurring components, including flavonoids, such as narirutin, hesperidin, limonoids. In '089, flavones, and other components were believed to detract from the quality of the fruit juice. While it is noted that the citrus fruit peel is high in desirable bioactive compounds, '089 teaches the removal of undesirable bitter compounds as well as some of the desirable bioactive compounds US Patent Application Publication No. 2006/0141114 A1 also teaches a process for processing any plant material residue, including grape and citrus fruit to produce a secondary juice that can be added to a primary juice.

U.S. Pat. No. 6,506,427 teaches a method for obtaining a super-cloud composition. In this method, at least one of a water soluble extract citrus solids, comprising peel core, cells, peel, frit, and compositions thereof was processed to obtain a retenant containing super-cloud composition. The retenant is said to contain some residues such as hydrocolloids, sugar, proteins, phenolic compounds, and bioflavonoids (esterified by glycosides and non-esterified compositions), but mainly insoluble polyphenols and bioflavonoids, in a solid crystalline form, such as naringine from grapefruit or hesperidin from oranges.

U.S. Pat. No. 7,108,887 discloses a process for enhancing a juice source by reducing or removing naturally occurring components from the juice source. The naturally occurring components that were reduced, includes limonoids, flavonoids, carotenoids polyphenolic compounds and flavones.

Whether during the processing of citrus juice or citrus juice by-products, the prior art shows that important quantities of phtyochemicals such as flavonoids are lost, because either the by-products of the juice process are considered waste, or the level of phtyochemicals in the by-product extraction process have been substantially reduced or removed as these components are thought to contribute undesirable qualities to the clouding agent. While these prior art extraction processes enable the loss, removal or reduction of important naturally occurring phytochemicals in the citrus fruit, the resultant juice is deficient in phytochemicals

In light of the present state of the art, the present invention provides a process for extracting flavonoid citrus extract from the by-product of a conventional juice extraction process. The extract obtained by this method is rich in flavonoids, captures the nutritional benefits of the whole citrus fruit, and can be added back in significant amounts to beverages, such as concentrated citrus juice, single strength citrus juice from concentrate, and not from concentrate citrus juice products, other non-citrus beverages, or used as a stand alone juice.

### SUMMARY OF THE INVENTION

In accordance with the present invention, citrus by-product sources are processed into a flavonoid citrus extract product which retains high levels of important phytochemicals of the citrus fruit, without compromising the taste or quality of the extract, and which can be added to concentrated citrus juice products, single strength citrus juice from concentrate, not from concentrated citrus juice products, other non-citrus beverage products or used as a stand alone juice.

Another object of the present invention is to retain important naturally occurring flavonoid phytochemicals lost in traditional citrus juice or by-product extraction processes.

Another object of the present invention is to provide improved citrus fruit processing and products which yield a flavonoid-rich citrus extract by extracting valuable phytochemicals from the separated core by-product from a citrus juice extraction.

Another object of the present invention is to provide a flavonoid citrus extract product, which has been extracted from the separated core by-product from the juice extraction process and subjected to an adsorptive polyester resin to reduce the level of bitterants, such as limonoids, without affecting the level of naturally occurring flavonoids, including flavanones and flavones.

Other aspects, objects and advantages of the present invention will be understood from the following description according to the preferred embodiments of the present invention, specifically including stated and the unstated combinations of the various features which are described herein, relevant information concerning which is shown in the accompanying drawing.

### BRIEF DESCRIPTION OF THE DRAWINGS

FIG. 1 is a schematic representation of a process that can be used in preparing the flavohoid citrus extract.

### DETAILED DESCRIPTION OF THE INVENTION

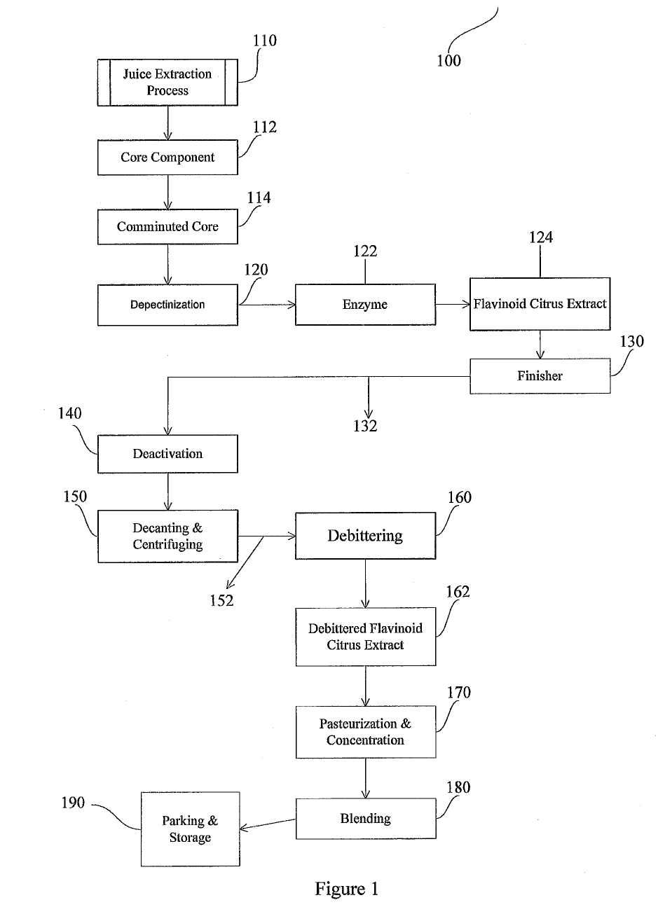

FIG. 1 illustrates a process 100 as is described here. In the process 100, a substantially raw core component 112 is the by-product that is separated from a conventional citrus juice extraction process 110, as is discussed above, using an extractor. The separated substantially raw core component 112 is recovered and transported with screw conveyors to mills to reduce the raw core component 112 into smaller pieces to provide a comminuted core 114. The communited substantially raw core 114 typically has a size of from about 0.5 mm to about 1.5 cm. Alternatively, a by-product such as a substantially citrus peel component, or the like, may also be used to produce the flavonoid citrus extract 124. The term “substantially” means at least 50% of the core component 112, or other citrus by-product, such as citrus peel or the like from a conventional citrus juice extraction process.

The resulting comminuted core 114 is passed to a de-pectinization tank 120, for mixing the comminuted core 114 with water. The ratio of comminuted core 114 to water is approximately 50:50. To the comminuted core 114 and water mixture, enzyme 122 is added. Typically a 100 ppm concentration of enzyme 122 is added to the de-pectinization tank 120. The enzyme 122 may be ROHACEPT® PTE, or a similar type enzyme may be used herein. The mixture of comminuted core 114, water and enzyme 122 is heated to a temperature of about 50°Celsius for about 20 minutes, to form a liquid flavonoid citrus extract 124. The concentration of 124 may be about 5.5°Brix.

The resulting liquid flavonoid citrus extract 124 will move to a finisher 130 in order to remove solid materials 132. The removed solid materials 132 removed may be used in the production of animal feed. A further mixer and finisher combination can be provided in order to affect a serial mixing and finishing so as to further refine the material and collect flavonoid extracts in addition to those extracted through the operation of the first mixer and finisher.

The liquid flavonoid citrus extract 124 from the finisher 130 is next fed to an enzyme de-activation device 140 to inactivate enzyme activity. Typically, the flavonoid citrus extract 124 is subject to de-activation for about 4 to about 8 minutes at a temperature of from about 90 to about 100°Celsius.

The resulting enzyme deactivated heated liquid flavonoid citrus extract 124 passes to a decanter and a centrifuge area 150, which is a two step process that reduces the level of suspended pulp 152. Typically, the suspended pulp 152 is first reduced in the decanter from about 2 to about 6%, and subsequently the suspended pulp 152 is reduced by centrifugation from about 0.5 to about 1.5%. After the suspended pulp 152 is reduced, the temperature of the liquid flavonoid citrus extract 124 may be reduced to a temperature of from about 50 to about 70°Celsius.

The liquid flavonoid citrus extract 124 in centrifuge area 150 moves to one or more debittering columns 160, for about 10 to about 18 minutes to reduce the level of undesirable bitter compounds, such as limonin to provide a debittered liquid flavonoid citrus extract 162. This results in the reduction of limonin to about 0.6 to 160 mg/liter at 11.8°Brix. Another compound falling within the limonoids group, e.g., nomilin, can also be reduced by this resin. Typical adsorption resins may be used in the debittering columns. Commercial adsorption systems are available for use in debittering columns 162. The polyester adsorption system used for debittering is Bucher Alimentech P495 resin.

The resulting debittered flavonoid citrus extract 162 contains levels of flavonoids, i.e., flavanones of at least 700 to at least 5,000 mg/liter when reconstituted to 11.8° Brix. The preferred level of flavanones in the flavonoid citrus extract is at least 1,500 mg/liter to about 4,800 mg/liter reconstituted to 11.8°Brix. The most preferred level of flavanones in the flavanoid citrus extract is at least 2,000 to at least 3,000 mg/liter when reconstituted at 11.8°Brix. The debittering columns 160 do not remove most of the flavonoids such as flavanones that may naturally occur in citrus fruit. Examples of compounds falling within the flavonoid group which are found in citrus fruits, such as oranges, are hesperidin, narirutin, didymin, and polymethoxy flavones. The individual and total concentration of the flavanones hesperidin, narirutin and didymin are measured and verified by an HPLC method.

Debittered flavonoid citrus extract 162 flows into a pasteurization and concentration area 170. The citrus extract 162 was pasteurized at a temperature of from about 90 to about 100°C., for about 0.5 to about 1.5 minutes. The citrus extract 162 was then held in a commercial T.A.S.T.E. Evaporator to be concentrated to 6°Brix.

The flavonoid citrus extract 162 can be prepared from the by-product of any citrus fruit, including, but not limited to oranges, mandarins, tangerines, blood oranges, grapefruits, lemons and limes, or the like, alone or in combinations

The resultant liquid flavonoid citrus extract 162 is collected and blended 180. Optionally, citric acid may be added to adjust the pH to the desirable value. The liquid flavonoid citrus extract 162 is packaged and stored 190. The liquid flavonoid citrus extract 162 may be packed aseptically or frozen. The liquid flavonoid citrus extract 162 can be stored for a period of up to two years.

The liquid flavonoid citrus extract 162 contains high levels of important flavonoids, which may be added to beverages, such as concentrated citrus juice, single strength citrus juice from concentrate, and not from concentrate citrus juice products, other non-citrus beverages, or used as a stand-alone juice.

The term “citrus” is meant to include all varieties from the commercially important species, such as Sweet orange (Citrus sinensis), Mandarin and Tangerine (Citrus reticulata), Grapefruit (Citrus paradisi), Lemon (Citrus limon) and Lime (Citrus aurantifolia). Preferred citrus fruits are oranges, including varieties such as Shamouti oranges, Valencia, Blood Oranges, Hamlin, Pera, Navel, Pineapple, Valencia, Salustianas, Blond, Parson Brown, and the like, alone or in combinations.

The term “phytonutrients” also known as “phytochemicals” refers to naturally occurring compounds in plants with beneficial effects on human health. There is no established recommended daily allowance (RDA) for phytonutrients and therefore, unlike essential nutrients, their values are not reflected on the Nutritional Facts panel on food products.

It should be apparent that the foregoing relates only to the preferred embodiments of the present application and that numerous changes and modifications may be made herein by one of ordinary skill in the art without departing from the general spirit and scope of the invention as defined by the following claims and equivalents thereof.

1. A process of extracting citrus flavonoids comprising:
a) separating substantially the core component from a citrus juice extraction process;
b) comminuting said citrus core component;
c) subjecting the comminuted citrus core component to enzymatic de-pectinization to form a flavonoid citrus extract;
d) debittering said flavonoid citrus extract, said debittering reducing the level of naturally occurring limonin; and
e) collecting the debittered flavonoid citrus extract, wherein the level of naturally occurring flavonoids is not reduced.

2. The process of claim 1, wherein the comminuted citrus core has a size of from about 0.5 mm to about 1.5 cm.

3. The process of claim 1, further comprises after step (c), the step of thermally de-activating the enzymes in the flavonoid citrus extract.

4. The process of claim 1, further comprises after step (c), the step of decanting and centrifuging said flavonoid citrus extract, to reduce the level of suspended pulp.

5. The process of claim 1, wherein said debittering contacts the flavonoid citrus extract with a polyester resin through a chromatography column.

6. The process of claim 1, further comprising after step (d), the step of thermally pasteurizing and concentrating the debittered flavonoid citrus extract.

7. The process of claim 6, wherein the debittered flavonoid citrus extract is concentrated to 65°Brix.

8. The process of claim 1, wherein the amount of flavanones in the flavonoid citrus extract collected is at least 700 mg/liter when reconstituted to 11.8°Brix.

9. The product produced by the process of claim 1.

10. A process of extracting citrus flavonoids comprising:
a) separating substantially the core component from a citrus juice extraction process;
b) comminuting said citrus core component;
c) subjecting the comminuted citrus core component to enzymatic de-pectinization to form a flavonoid citrus extract;
d) thermally de-activating the enzymes in the flavonoid citrus extract;
e) decanting and centrifuging said flavonoid extract, said decanting and centrifuging reducing the level of suspended pulp;
f) debittering said flavonoid citrus extract, said debittering reducing the level of naturally occurring limonin;
g) thermally pasteurizing and concentrating said debittered flavonoid citrus extract; and
h) collecting the pasteurized, debittered flavonoid citrus extract, wherein the level of naturally occurring flavonoids is not reduced.

11. The process of claim 10, wherein the comminuted citrus core has a size of from about 0.5 mm to about 1.5 cm.

12. The process of claim 10, wherein said debittering contacts the flavonoid citrus extract with a polyester resin through a chromatography column.

13. The process of claim 10, wherein the flavonoid citrus extract is concentrated to 65°Brix.

14. The process of claim 10, wherein the amount of flavanones in the flavonoid citrus extract collected is at least 700 mg/liter when reconstituted to 11.8°Brix.

15. The product produced by the process of claim 10.

16. A process of extracting citrus flavonoids comprising:
a) separating substantially the citrus peel component from a citrus juice extraction process;
b) comminuting said citrus peel component;
c) subjecting the comminuted citrus peel component to enzymatic de-pectinization to form a flavonoid citrus extract;
d) debittering said flavonoid citrus extract, said debittering reducing the level of naturally occurring limonin; and
e) collecting the debittered flavonoid citrus extract, wherein the level of naturally occurring flavonoids is not reduced.

17. The product produced by the process of claim 16.

18. A process of extracting citrus flavonoids comprising:
a) separating substantially the citrus peel component from a citrus juice extraction process;
b) comminuting said citrus peel component;
c) subjecting the comminuted citrus peel component to enzymatic de-pectinization to form a flavonoid citrus extract;
d) thermally de-activating the enzymes in the flavonoid citrus extract;
e) decanting and centrifuging said flavonoid extract, said decanting and centrifuging reducing the level of suspended pulp;
f) debittering said flavonoid citrus extract, said debittering reducing the level of naturally occurring limonin;
g) thermally pasteurizing and concentrating said debittered flavonoid citrus extract; and
h) collecting the pasteurized, debittered flavonoid citrus extract, wherein the level of naturally occurring flavonoids is not reduced.

19. The product produced by the process of claim 18.
